(19) United States
(12) Patent Application Publication
(10) Pub. No.: US 2005/0132933 A1
(43) Pub. Date: Jun. 23, 2005

(54) Method and apparatus for control of kiln feed chemistry in cement clinker production

(76) Inventor: Bernard Blum, Buffalo, NY (US)

Correspondence Address: HODGSON RUSS LLP, ONE M & T PLAZA, SUITE 2000, BUFFALO, NY, 14203-2391, US

(21) Appl. No.: 11/017,982

(22) Filed: Dec. 20, 2004

Related U.S. Application Data
(60) Provisional application No. 60/589,155, filed on Jul. 19, 2004.
(60) Provisional application No. 60/530,775, filed on Dec. 18, 2003.

(51) Int. Cl. C04B 2/10

(52) U.S. Cl. 106/739

(57) ABSTRACT

A method and apparatus for controlling cement clinker production uses a detection device disposed proximate to the feed end of a rotary cement kiln to detect the chemical analysis of a combined additive/kiln feed mixture. A controller changes the feed rate of the additive feeder to adjust for differences between the detected chemical composition and a chemical target specification such as tricalcium silicate, tricalcium aluminate, lime saturation, silica ratio or aluminum to iron ratio. The timely and convenient adjustment of kiln feed chemistry provides more uniform kiln feed chemistry resulting in better kiln operation in terms of productivity, fuel efficiency and less refractory wear. This method and apparatus can provide chemical adjustments for different grades of clinker.

### CROSS-REFERENCE TO RELATED APPLICATION

This application claims the benefit of U.S. Provisional Patent Application No. 60/530,775 filed on Dec. 18, 2003, and U.S. Provisional Patent Application No. 60/589,155 filed on Jul. 19, 2004.

### FIELD OF THE INVENTION

This invention relates in general to the manufacture of Portland cement clinker; hereafter referred to as “clinker.” In particular, the invention relates to a method and apparatus for the manufacture of clinker in a conventional wet kiln, dry kiln or preheater rotary kiln.

### BACKGROUND OF THE INVENTION

The process of clinkering cement raw materials using a rotary kiln, either wet, dry or preheater, is well known. In addition to limestone, common raw materials for the production of clinker are clay, shale, fly ash and iron oxide. As limestone deposits are not uniform, the chemical analysis of the quarried stone will vary. Accordingly, it is common practice to mix quarried limestone with clay, shale, fly ash and iron oxide in various proportions and control these natural chemical variations in order to achieve a targeted chemical set-point. All of the above materials are usually finely ground and blended in an attempt to provide a substantially homogeneous chemical content of kiln feed at the input-end or feed-end of the kiln.

Successful kiln operation is a function of the chemical uniformity of this blend of raw materials. Large changes in the chemical uniformity of the kiln feed will cause kiln upsets, poor quality clinker, higher fuel costs and undesirable refractory deterioration.

To keep the kiln feed chemically uniform, the raw material streams are blended in a homogenization system. These homogenization systems may comprise one or more large storage silos or storage basins and typically contain several days inventory of kiln feed.

Even with homogenization, there are still excessive variations in kiln feed chemistry from time-to-time that result in poor kiln operations and inferior clinker quality and cement performance. Abnormal chemical variations in the raw feed chemistry can result from a number of reasons. A few examples include raw material feeder starvation, raw material contamination with other raw materials, x-ray malfunction, sampling error, etc. Raw mix manufactured from any of these abnormal chemical variations proceeds to the homogenization inventory storage and cannot be corrected on a timely basis due to the large quantity of inventory and the amount of bias from the desired chemical set-point. Typical practice is to make chemical corrections in the raw mill system by adjusting the raw material feeders to achieve a temporary off-specification chemical set-point until correction of the inventory in the blend silo system is completed. This slowly dilutes and corrects the chemical bias throughout the inventory stored in the homogenization storage. However, the lag time for this chemical correction to be realized is usually a very long time taking more than twenty-four hours in many cases. During this lag time required to effectively make the chemical correction to the homogenization storage inventory, kiln feed that does not meet the chemical set-points is being withdrawn from the homogenizing system and fed into the kiln. This results in kiln upsets, poor quality clinker, higher fuel costs and undesirable refractory deterioration. This lag time is caused by the typical homogenization process and makes it impossible to deal with short term fluctuations in kiln operating conditions on a timely basis.

Accordingly, there is a need for a control system and method to fine tune the chemical uniformity of the kiln feed coming from the homogenization system and into a cement kiln that would correct the chemical bias from the primary raw mill control and in the homogenizing system and also reduce the lag time required for the adjustment to be realized. More timely correction of the chemical bias of the kiln feed benefits kiln operation in terms of fewer upsets, better clinker quality and cement performance, lower fuel costs and less refractory deterioration.

### SUMMARY OF THE INVENTION

The present invention meets the above-described need by providing a control system for varying the amount of slag or type of slag fed into the kiln to compensate for chemical changes detected in the kiln feed.

Additionally, this system can be used to facilitate changes in the clinker chemistry that will produce different types of clinker that are routinely required in cement manufacture. Type I clinker is typically used for general construction and type II clinker with lower C₃A content is used in construction where lower heat of hydration or resistance to sulfate attack is needed.

### BRIEF DESCRIPTION OF THE DRAWING

FIG. 1 is a diagrammatic representation of the cement manufacturing material flow and rotary kiln system of the present invention for forming clinker in which the kiln feed material and the metallurgical slag are fed separately into the feed-end of the rotary kiln and controlled in a manner to improve uniform chemical consistency of the kiln feed.

### DETAILED DESCRIPTION OF INVENTION

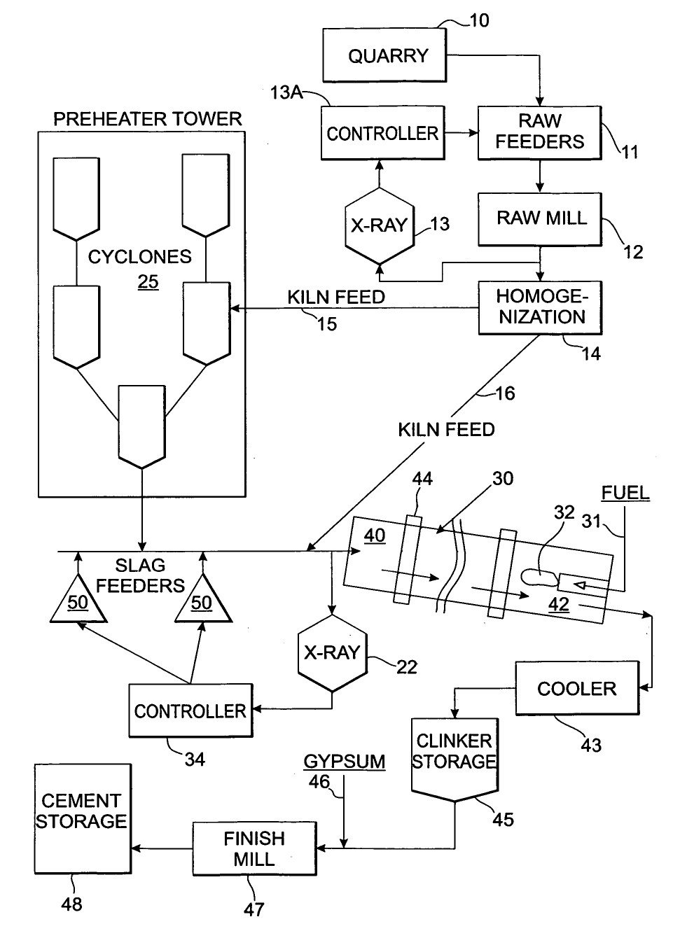

The apparatus of the present invention is illustrated in FIG. 1. The kiln feed 15, 16 referred to above comes from the homogenizing storage system 14 and is comprised of limestone from the quarry 10 and several raw materials such as clay, shale, fly ash and iron oxide that are proportioned together from the raw feeders 11, ground in a raw mill 12, and blended in a homogenization storage system 14. The chemistry of the resulting blend of raw materials is tested on a routine basis by an x-ray 13 spectrometer or other method of analysis. Based on these x-ray results the proportions of the various raw materials feeders 11 are adjusted as necessary by the controller 13A to achieve the desired chemical targets. This process for adjusting the raw material feeders is known to those of ordinary skill in the art. Chemical targets, referred to as ratios, that are used for clinker manufacture are tricalcium silicate written as C₃S and tricalcium aluminate written as C₃A, although other ratios and various combinations of lime saturation written as LSF, silica ratio written as SR and aluminum to iron ratio written as AF could be used as well depending on the chemistry of the raw materials. These ratios are calculated from the x-ray analysis. For this example the mixture of raw materials would have a C₃S target of 65. The major raw ingredient for production of clinker is limestone mined from a quarry 10, typically the C3S of the limestone would be 200. The limestone may include two or more grades of stone with different chemical make-up that are obtained from one or more quarries 10 and the C₃S could vary over a wide range. The quarried stone is crushed and then proportioned through the raw feeders 11 and ground in a raw mill 12 along with the other raw materials. The other raw materials are used to adjust the chemistry. Clay, shale and fly ash have a C₃S of approximately minus 500. Iron oxide has an approximate C₃S of minus 100. After the stone and raw materials are ground in the raw mill they are analyzed by the x-ray 13. The x-ray analysis is done on a periodic or continuous basis. The x-ray 13 test results are processed through controller 13A and the raw material feeders 11 are adjusted as needed to achieve the desired raw mix chemical targets for C₃S of 65 used in the example. Basically, more limestone would increase the C₃S and more clay or shale would decrease the C₃S. The resulting combination of raw materials proceed to the homogenization system 14 and become kiln feed.

Kiln feed 15, 16 and slag 50 are combined prior to entering the feed end 40 of the kiln 30. Slag has been used in this description to control kiln feed chemistry but other materials such as, but not limited to, iron oxides, fly ash, bottom ash, fine silica and sewage sludge could also be used in addition to the slag or as a replacement for the slag.

The metallurgical slag is stored in a slag feeder 50 or slag feeders 50 if more than one slag feeder is used for different compositions or types of slag. These slag feeders 50 proportion the slag as needed based on input from the x-ray 22 and controller 34 together along with the kiln feed 15,16 into the feed-end 40 of the rotary kiln 30. If convient, x-ray 13 or any other method for chemical testing could be used in place of x-ray 22 to test the combination of slag from feeder 50 and kiln feed 15,16 with the test results then processed through controller 34.

Slag has an approximate C₃S of minus 150. The composition of the slag 50 and the fuel ash resulting from the coal used to fire the kiln further affects these ratios resulting in clinker meeting the desired set-point for C₃S of 55. To clarify, for this example the desired kiln feed C₃S of 65 would typically yield clinker with the desired C₃S of 55 with the difference due to the effect of the slag and fuel ash.

The burning apparatus includes a rotary kiln 30 supported in a well-known manner by flanges 44 that rotate with the kiln. The kiln has a feed-end 40 and a heat-end 42. The heat-end 42 is tilted downwardly with respect to the feed-end 40 as is well known in the art. The kiln rotates to move material through the burning process from the feed-end 40 to the heat-end 42. A fuel source 31 creates a flame 32 in the heat-end 42 of the rotary kiln 30 to provide a clinker temperature of approximately 1500° C. (2732° F.). Conventional fuel is combined with preheated air and injected into the kiln at the heat-end 42. Fuels such as natural gas, oil, coal, coke and/or solvents are typically used in cement manufacturing processes.

The kiln has generally four operating zones including a precalcining zone, a calcining zone, a clinkering zone, and a cooling zone. In the case of preheater type kilns, the precalcining and a portion of the calcining is done outside the kiln 30 in a series of cyclones 25 that facilitate heat transfer into the kiln feed from the hot kiln gases exiting the kiln. The remaining clinker formation takes place in the kiln 30. In the case of a preheater kiln the kiln feed 15 is fed into the heat exchanging cyclones and then proceeds into the feed-end 40 of the kiln 30. In the case of wet kilns 30 and dry kilns 30, there are no preheater cyclones 25 and the kiln feed 16 passes into the rotating kiln 30 at the feed-end 40 along with the slag or other raw material provided by the slag feeder 50. In the kiln the kiln feed 16 is precalcined, calcined, clinkered and cooled and made into clinker. The slag 50 has already been precalcined and calcined.

During the clinker burning process in the rotary kiln the raw materials are converted into the typical cement compounds such as tricalcium silicate 3CaO.SiO₂ (C₃S), dicalcium silicate 2CaO.SiO₂ (C₂S), dicalcium ferrite 2CaO.Fe₂O₃ (C₂F), tetracalcium aluminoferrite 4CaO.Al₂O₃.Fe₂O₃ (C₄AF), tricalcium aluminate 3CaO.Al₂O₃ (C₃A), etc.

The clinker then leaves the hot-end 42 of the kiln 30 and into the clinker cooler 43 where the clinker is further cooled and then to clinker storage 45 and, thereafter, processed further by grinding in a finish mill 47 with a small addition of gypsum 46 into the Portland cement storage 48.

The term “metallurgical slag” is intended to include both blast furnace slag and steel slag, cooled in any manner, as well as any other type of slag derived from other metals that is suitable for processing with cement raw materials in the manufacture of Portland cement clinker.

Slag is a by-product of the production of iron. In the iron manufacturing process the blast furnace is periodically charged from the top with iron oxide sources, fluxing stone, and fuel. Two products are obtained from the furnace: molten iron that collects in the bottom of the furnace and liquid iron blast-furnace slag floating on the pool of iron. Both are periodically tapped from the furnace at a temperature of about 1500° C. (2732° F.). The slag consists primarily of silica and alumina combined with calcium and magnesium oxides from the fluxing stone. Cementitious activity of this slag for use in mortar or concrete is determined by its composition and the rate at which the molten material is cooled when it comes from the blast furnace. Further, in the production of steel, a similar process occurs in the steel furnace wherein liquid steel slag floats on the pool of steel. Again, the steel slag consists primarily of silica and alumina combined with calcium and magnesium oxides. Disposing of both the steel slag and the blast-furnace slag poses a major disposal problem for the manufacturer thereof because of the amount of materials involved. Many of the chemical compounds in steel slag and blast-furnace slag are common to cement chemical compounds and their heat of formation is already been accomplished in their-respective processes. The American Concrete Institute defines blast-furnace slag as follows:

blast-furnace slag—the nonmetallic product, consisting essentially of silicates and aluminosilicates of calcium and other bases, that is developed in a molten condition simultaneously with iron in a blast furnace.

1. air-cooled blast-furnace slag is the material resulting from solidification of molten blast-furnace slag under atmospheric conditions: subsequent cooling may be accelerated by application of water to the solidified surface.

2. expanded blast-furnace slag is the lightweight, cellular material obtained by controlled processing of molten blast-furnace slag with water, or water and other agents, such as steam or compressed air, or both.

3. granulated blast-furnace slag is the glassy, granular material formed when molten blast-furnace slag is rapidly chilled, as by immersion in water.

Both blast-furnace slag and steel slag, with the addition of CaO, can be converted to various combinations of tricalcium silicate 3CaO.SiO₂ (C₃S), dicalcium silicate 2CaO.SiO₂ (C₂S), dicalcium ferrite 2CaO.Fe₂O₃ (C₂F), tetracalcium aluminoferrite 4CaO.Al₂O₃.Fe₂O₃(C₄AF), tricalcium aluminate 3CaO.Al₂O₃(C₃A) in the burning zone of the rotary kiln.

The present invention by providing a method, system and apparatus to adjust the chemical composition of the kiln feed just prior to entering the kiln can reduce the size of homogenization equipment required in the clinker manufacturing process, correct for excessive chemical variations due to the inherent lag time in the homogenization system or adjust for other changes in the clinker manufacturing process. Changes between types of clinker can also be accomplished with the method and apparatus.

The method consists of:
a) Setting a chemical target specification for the kiln feed; Example: C₃S 65;
b) Setting an acceptable bias to the chemical target for the kiln feed large enough to encompass normal variations in the feed; Example: C₃S 65 plus or minus 5 C₃S;
c) Determine the actual chemical composition of the kiln feed; Example: Using x-ray 22; kiln feed C₃S is determined to be 75 which is above the desired chemical target specification; and,
d) Adjusting for differences from kiln feed chemical target specification due to lag time from the homogenizing system or from other changes in the clinker manufacturing process by adding or subtracting one or more components of slag in sufficient quantity to correct the bias and any differences from the desired chemical target; Example: Since kiln feed C₃S is 75 and desired C₃S is 65, the slag feeder 50 can be increased to correct the kiln feed C₃S from 75 to 65.

Examples of process changes requiring chemical correction could include differences in kiln dust loss when the raw mill is operating or when the raw mill is on standby, raw mill stopped for repair, changes in fuel ash content, etc. A specific example of a typical process change that would benefit from the slag correction could be when the raw mill 12 is down for maintenance and the kiln dust is returned to the homogenizing system 14 reducing the kiln feed C₃S to 55. The desired C₃S of the kiln feed is 65 so the slag feeder 50 can be reduced to achieve the desired C₃S of 65 in the kiln feed 15.

Applying the method to the uniform production of clinker chemistry, a controller 34 receives data from an x-ray analyzer 22 that has sampled and analyzed the combined kiln feed 15, 16 and slag 50 entering the feed-end 40 of the kiln 30. By using controller 34 to vary the slag from slag feeder 50 entering into the kiln 30, the key kiln feed chemical targets can be controlled to the desired chemical set-points. For example, if the slag feeders 50 are a belt conveyor system the controller 34 would increase or decrease the speed of the conveyor belt in order to increase or decrease the amount of slag that is fed into the kiln 30. Because the slag 50 is mixed with the kiln feed 15,16 and fed directly into the feed-end 40 of the kiln 30, the lag times inherent in the raw mill proportioning and homogenization process (steps 11, 12, 13, 13A and 14) are avoided, thereby resulting in beneficial improvement to the kiln operation in terms of increased productivity, fuel efficiency, and avoided refractory wear and damage.

An example of these benefits is described follows: Due to a clay feeder starvation at the raw feeders 11 the kiln feed C₃S tested by x-ray 22 is currently 75 and the desired set-point is 65. This difference is too great and will potentially cause the burning problems described earlier. In this example the amount of slag is increased by controller 34 through slag feeders 50 and the resulting kiln feed chemistry returns from C₃S 75 to the desired set-point of 65 C₃S. This timely correction improves the kiln productivity, fuel efficiency, results in more uniform clinker chemistry and reduces refractory wear.

By controlling the amount of slag fed to the kiln described in this patent, the control system 34 has the ability to adjust the C₃S of the clinker, which is one of the primary parameters with regard to the stable and beneficial behavior of the kiln and the uniform performance of the finished cement.

An additional benefit of this method is to use the apparatus for adjusting the slag, slag components, or other raw materials to change clinker types from type I to type II or vice-versa. Changes in clinker chemistry for other types of clinker including oil-well clinker or other specialty clinker types can also be done.

An example to illustrate the method, apparatus, and system for changing clinker from type I to type II follows: Blast furnace slag is currently being used in the slag feeders 50. The plant management plans to change from type I clinker to type II clinker and would replace the blast furnace slag in slag feeder 50 with steel slag. The blast furnace slag has a C₃A content of 15 and the steel slag has a C₃A content of minus 20. By replacing the blast furnace slag with the steel slag in the correct proportion this would reduce the C₃A of the clinker from 9 to 6 and meet the specifications for type II clinker. If the plant has two slag feeders 50 available then blast furnace slag could be stored in one of the slag feeders 50 and steel slag with different chemical composition stored in the other slag feeder 50. The two slag feeders then could be adjusted as indicated by the analyzer 22 to control the C₃A content of the kiln feed. Additionally, the C₃A content of the kiln feed could be fine-tuned and controlled by adjusting the slag feeder 50 containing blast furnace slag and the slag feeder 50 containing steel slag through the control loop of x-ray 22 and controller 34.

While the invention has been described in connection with a preferred embodiment, it is not intended to limit the scope of the invention to the particular form set forth, but, on the contrary, it is intended to cover such alternatives, modifications, and equivalents as may be included within the spirit and scope of the invention as defined by the appended claims.

1. A method of cement clinker manufacture using a rotary cement kiln having a feed end and a heat end, the heat end being tilted downwardly with respect to the feed end, the method comprising:
a) providing a stream of a kiln feed material;
b) adding an amount of an additive material to the kiln feed material to produce a combined additive/kiln feed material;
c) measuring the chemical composition of the combined additive/kiln feed material at a position proximate to the feed end of the kiln;
d) comparing the chemical composition of the combined additive/kiln feed material to a chemical target specification; and,
e) adjusting for differences from the chemical target specification by changing the amount of the additive material that is added to the kiln feed material to meet the chemical target specification.

2. The method of claim 1, wherein the additive material is selected from the group consisting of: slag, iron oxide, fly ash, bottom ash and silica.

3. The method of claim 1, wherein the chemical target specification comprises tricalcium silicate.

4. The method of claim 1, wherein the chemical target specification comprises tricalcium aluminate.

5. The method of claim 1, wherein the chemical target specification comprises lime saturation.

6. The method of claim 1, wherein the chemical target specification comprises silica ratio.

7. The method of claim 1, wherein the chemical target specification comprises an aluminum to iron ratio.

8. A method of cement clinker manufacture using a rotary cement kiln having a feed end and a heat end, the heat end being tilted downwardly with respect to the feed end, the method comprising:
a) providing a stream of a kiln feed material;
b) adding an amount of slag to the kiln feed material to produce a combined slag/kiln feed material;
c) measuring the chemical composition of the combined slag/kiln feed material at a position proximate to the feed end of the kiln;
d) comparing the chemical composition of the combined slag/kiln feed material to a chemical target specification; and,
e) adjusting for differences from the chemical target specification by changing the amount of slag that is being added to the kiln feed material to meet the chemical target specification.

9. The method of claim 8, wherein the slag is metallurgical slag.

10. The method of claim 8, wherein the slag is steel slag.

11. The method of claim 8, wherein the slag is blast furnace slag.

12. The method of claim 8, wherein the chemical target specification comprises tricalcium silicate.

13. The method of claim 8, wherein the chemical target specification comprises tricalcium aluminate.

14. The method of claim 8, wherein the chemical target specification comprises lime saturation.

15. The method of claim 8, wherein the chemical target specification comprises silica ratio.

16. The method of claim 8, wherein the chemical target specification comprises an aluminum to iron ratio.

17. The method of claim 8, wherein the slag is added into the stream of kiln feed material by a slag feeder.

18. The method of claim 8, wherein the slag is added into the stream of kiln feed material by at least two slag feeders.

19. The method of claim 18, wherein the at least two slag feeders comprise a first slag feeder containing a first material and a second slag feeder containing a second material of different chemical composition.

20. The method of claim 19, further comprising switching between the first and second slag feeders to produce a different type of clinker.

21. An apparatus for cement clinker production using a rotary cement kiln having a feed end and a heat end, the heat end being tilted downwardly with respect to the feed end, the apparatus comprising:
at least one additive feeder disposed proximate to the feed end of the kiln such that an additive can be combined with a kiln feed material prior to entering the feed end of the kiln to produce a combined additive/kiln feed material;
a detection device disposed proximate to the feed end of the kiln to measure the chemical composition of the combined additive/kiln feed material; and,
at least one controller capable of comparing the chemical composition of the combined additive/kiln feed material with a chemical target specification and adjusting the at least one additive feeder in response to differences from the chemical target specification to meet the chemical target specification.

22. The apparatus of claim 21, wherein the additive is selected from the group consisting of: slag, iron oxide, fly ash, bottom ash and silica.

23. The apparatus of claim 21, wherein the second chemical target specification is selected from the group consisting of: tricalcium silicate, tricalcium aluminate, silica ratio, lime saturation, and aluminum to iron ratio.

24. The apparatus of claim 21, wherein the at least one additive feeder comprises a first additive feeder containing a first material and a second additive feeder containing a second material of different chemical composition.
